(19) United States
(12) Patent Application Publication
(10) Pub. No.: US 2006/0202468 A1
(43) Pub. Date: Sep. 14, 2006

(54) Security document having integrated copy-void and validation security features

(75) Inventors: George K. Phillips, Paso Robles, CA (US); Noal S. Phillips, Paso Robles, CA (US)

Correspondence Address: Vista IP Law Group LLP, 2040 MAIN STREET, 9TH FLOOR, IRVINE, CA, 92614, US

(73) Assignee: Verify First Technologies, Inc., Paso Robles, CA (US)

(21) Appl. No.: 11/062,989

(22) Filed: Feb. 22, 2005

(51) Int. Cl. B42D 15/00

(52) U.S. Cl. 283/72

(57) ABSTRACT

Documents for minimizing and detecting fraudulent activity are provided. The document comprises a printable substrate, a first security feature that forms a latent copy-void warning message that visually appears on an electronically printed reproduction of the document original, and a second security feature that forms a latent validation message that visually appears on a digital reproduction of the document original. This arrangement allows a possessor of the printed document reproduction to quickly identify it as a counterfeit by virtue of the presence of the copy-void warning message on the document original, and allows an inspector of a digital document reproduction to quickly identify it as an authentic digital reproduction of the document original by virtue of the presence and exactness of the validation message. The second security feature is at least partially embedded, and can be completely embedded, within the first security feature. In this manner, a criminal who attempts to circumvent the first security feature by removing the latent copy-void warning message, will inadvertently remove the latent validation message. As a result, any document generated from such fraudulent activity will not contain the validation message, thereby indicating to an inspector of the digital image that it was not generated from the document original. Methods for authenticating a digital reproduction of an original document are provided. The document original carries nano-structures that form a latent message, such as a validation message. The method comprises creating the digital document reproduction, examining the digital document reproduction for the message, which can be done manually or automatically, and authenticating the digital document reproduction based on the examination. If the message is a validation message, its identification may be used to conveniently authenticate the digital image. Another method comprises digitally reproducing the document original to form a pixel pattern representing the message, comparing the pixel pattern with a reference pixel pattern, and authenticating the digital document reproduction based on the comparison. The pixel pattern comparison may be accomplished manually, but preferably is accomplished by a machine automatically in order to facilitate the authentication process. In one method, the reference pixel pattern is obtained by digitally reproducing a known sample of the document original. The nano-structures may be optionally modulated, so that any pixel pattern differences between the digital document reproduction and the sample image is accentuated. Documents that confine a multitude of latent messages in a single region are provided. The document comprises a printable substrate, a latent message having a visual density configured to change in the presence of an environmental condition to activate the latent message on the document original, and a normally visible message having a visual density configured to change in the presence of the environmental condition (e.g., a thermal condition involving an increase in temperature) to deactivate the normally visible message. The latent message and the normally visible message spatially overlap with each other, so that, e.g., the messages can be confined to a single region. Because only one of the messages is intended to be activated at a given time, they can co-exist. The latent message may, e.g., a validation message, and the normally visible message may be, e.g., bearer information, e.g., bank check bearer information. The normally visible message may also occupy a region defining a bearer field, e.g., a signature field.

### FIELD OF THE INVENTION

The present inventions pertain to documents, and in particular, counterfeit-resistant security documents.

### BACKGROUND OF THE INVENTION

Combating document fraud and protecting printed content is a multi-disciplinary and international concern. The constant improvement of modern scanners with digital signal processing means and color copiers has made it economically feasible to reproduce almost perfect reproductions of currency and fraudulent travel documents. This same technology is now used everyday to counterfeit valuable documents, such as bank checks, stock certificates, bonds, etc. Many different security printing techniques have been developed to alert a casual observer of a fraud attempt at the time of general inspection. Of particular importance to the present invention is the detection of fraud within the banking industry, and specifically, during the presentment and check clearing process.

The check presentment and clearing process begins with the owner of a check (the “Payor”) issuing the check to an entity for payment (the “Payee-Depositor”). The Payee-Depositor deposits the check at a bank (the “Bank of First Deposit”), which will be typically be the bank at which the Payee-Depositor has an account. The Bank of First Deposit then determines whether the check is an in-house item (i.e., drawn against itself) or an external item that needs to be submitted to another bank (the “Payor Bank”) for payment either directly or through an intermediary bank (typically, the Federal Reserve). Upon receipt of the check, the Payor Bank sorts it, along with all of the other checks received by the bank that day, and establishes which account the check is drawn against, which will be Payor's account. The Payor Bank must promptly determine whether or not to honor the check. If it does, the Payor Bank will debit the Payor's account and directly or indirectly transfer funds to the Bank of First Deposit. The Payor Bank may return the processed check to the Payor, although most banks have now eliminated the actual return of the processed check to the Payor. If the Payor Bank decides not to honor the check (e.g., if the account has insufficient funds), the Payor Bank must either return the check, or send a notice of intent not to pay the check. If the Payor Bank does not perform one of these steps within a given time, currently by midnight of the day that the check was received by the Payor Bank, it is liable for the amount of the check with few exceptions. Once the Payor Bank transfers funds, the Bank of First Deposit credits the Payee-Depositor's individual account.

To facilitate their processing, checks consist of a defined format regulated through standards developed over the years. The format consists of a limited number of fields that are located in predefined areas, so that the checks can be quickly and efficiently processed. The front of the check include the account and bank number on which the check is drawn, date, payee, amount to be paid, and approval signature. The account number, routing code, and check number are printed on Magnetic Ink Character Recognition (MICR) line at the bottom of the check, so that the information can be magnetically read at high speed. The back of the check contains endorsement information.

Currently, there are several ways in which criminals can pass a fraudulent check through the check clearing system. For example, a criminal can steal blank checks from the Payor and simply forge the Payor's name onto the checks. Absent the exercise of diligence, which typically involves requesting picture identification at the point of original check presentation or comparing a known signature of the Payor with the signature endorsed on the check, there is no effective means of preventing such a fraudulent check from passing through the check clearing system. More commonly, the criminal can steal legitimately endorsed checks from the Payor (e.g., out of his or her mailbox), remove ink from the payee line of the check (e.g., mechanically using a knife or abrasive tool or chemically using a special chemical solution), and rewrite the checks to themselves, sometimes for much higher amounts than what they were originally written for (e.g., by changing $200 to $2000). Another type of check fraud involves counterfeiting, where the criminal makes a color copy of a blank or endorsed check, or otherwise scans the check at a high resolution, and possibly after modifying the image, printing the image out as a check, after which it can then be passed off as an original of the check.

There are several stages of a typical check clearing process during which a fraudulent check can be detected. For example, a fraudulent check can be detected by the Payee-Depositor prior to depositing the check at the Depository Bank, can be detected by the Bank of First Deposit prior to presenting the check to the Payor Bank or intermediate bank, or can be detected by the Payor Bank prior to transferring the funds to the Depository Bank. Despite the many security technologies that are applied to checks today, many fraudulent checks still pass through the banking system, and are only detected (if they are detected at all) by the Payor well after the funds have been transferred from his or her individual account to the Payee-Depositor's account.

Once a fraudulent check enters the check clearing system, someone will be liable for payment of that check. The general rule is that, as long as the Payor's checks are enabled with sufficient security technology, the last entity that accepts the check will be liable for payment subject to any indemnification or shared loss agreement that such entity has with the transferor of the check. Thus, it can be appreciated that the use of robust security technology on checks not only prevents or minimizes the chances that the Payor will be victimized by fraud, but also transfers the risk of liability to entities downstream from the Payor.

Previously, a bank that presented a check for payment must have presented the original paper check unless the paying bank had agreed to accept presentment from the collecting bank in some other form. As a result, absent such an agreement, any entity within the check clearing system was capable of examining the security technology on an original check to confirm authenticity of the check and to determine whether to make payment on the check. If found fraudulent, the paper check was also available during an investigation, which can reveal the nature and the party responsible for the fraudulent activity. Any information resulting from such investigation could then be used to determine whether the identified suspect should be charged. The original check, itself, could then be used as legally acceptable evidence to prosecute suspect once he or she was charged.

The Check Clearing for the 21^{st} Century Act, the legislation known as “Check 21”, was signed into law on Oct. 28, 2003, and went into effect Oct. 28, 2004. In large part, Check 21 was designed in response to the 9/11 terrorist activity, which caused severe delays in transporting physical checks within the check clearing system, thereby costing financial institutions billions of dollars a day in interest payments.

Check 21 allows, but does not require, any entity in lawful possession of an original paper check to truncate it (i.e., remove an original paper check from the check clearance process) and convert it to a digital image. Any entity downstream from the converting entity must either accept the digital image or accept a “substitute check,” which is a paper reproduction of the original check containing an image of the front and back of the original check and bearing a MICR line containing all the information appearing on the MICR line of the original check. A substitute check that meets certain criteria is the legal equivalent of the original for all purposes under state and federal law.

It is expected that the generation and processing of digital check images will greatly improve the clearing of checks. This is especially the case if digital images, rather than substitute checks, are transferred between entities during the check clearing process, since paper moves relatively slowly and requires couriers, whereas digital information moves instantly and is easier to process, store, search, and retrieve.

While Check 21 will significantly speed the handling and collection of checks, it also presents challenges to fraud prevention and prosecution. For example, many security technologies will not survive the imaging process—especially since images will be scanned at a low resolution of 200 or 240 dots-per-inch (dpi), as required by the Federal Reserve. In fact, because billions of check images will have be stored, any security technology that presents itself as a solid black image will be quite disadvantageous, and thus undesirable, in that it may cause the size of the image file to be too large.

Not only does the imaging process tend to nullify the security technologies carried by original checks, it has a great impact on liability. Check 21 is basically designed to place the liability and losses associated with a substitute check on the bank that transfers it downstream in the check clearance process. In particular, Check 21 states that “A bank that transfers, presents, or returns a substitute check or a paper or electronic representation of a substitute check for which it receives consideration shall indemnify the recipient and any subsequent recipient (including a collecting or returning bank, the depositary bank, the drawer, the drawee, the payee, the depositor, and any indorser) for any loss incurred by any recipient of a substitute check if that loss occurred due to the receipt of a substitute check instead of the original check.”

Thus, the indemnity covers losses that were incurred by any recipient of a substitute check as a result of a receipt of the substitute check instead of the original check. In this case, the Payor Bank could make an indemnity claim if it could show that, had it instead received the original check, its fraud detection procedures would have detected the fraudulent item in time for the bank to return the item in a timely manner. As an example, the Federal Reserve provides the following scenario. “A paying bank makes payment based on a substitute check that was derived from a fraudulent original cashier's check. The amount and other characteristics of the original cashier's check are such that, had the original check been presented instead, the paying bank would have inspected the original check for security features and likely would have detected the fraud and returned the original check before its midnight deadline. The security features that the bank would have inspected were security features that did not survive the imaging process. Under these circumstances, the paying bank could assert an indemnity claim against the bank that presented the substitute check.”

Thus, it can be appreciated that an image survivable security feature may tend to shift liability downstream from each bank that transfers the substitute check, whereas a security feature that does not survive image will tend to maintain liability with the first bank that transfers the substitute check.

In addition, because the length of time that the original check must be maintained is not set by law (although it can be set by clearinghouse rules and other agreements), a substitute check may be all that is available for investigation and prosecution of a suspect in any given case. However, the conversion process destroys much of the evidence of fraud, e.g., the ability to do ink analysis, some aspects of handwriting analysis, paper stock analysis, etc. In most cases, a substitute check will not even reveal the nature of the fraud, e.g., whether the fraudulent check was stolen (whether altered or not) or counterfeited, or in some rare cases, whether the Payor falsely reports fraud for their own financial gain.

Besides the challenges that Check 21 presents, there are also challenges in incorporating multiple security features into a bank check in a manner that allows a possessor of the check to verify its authenticity. However, there is only a limited amount of space on a bank check to incorporate multiple security technologies, which is often spatially distributed in various regions on the check, thereby making it more difficult to verify the authenticity of the check.

Based on the foregoing, there remains a need to provide a security paper technology that not only works well within the new Check 21 clearing system, but also will survive the imaging process and be conveniently located within a single region on the bank check.

### SUMMARY OF THE INVENTION

In accordance with the present inventions, original documents and authentication methods that minimize or prevents fraudulent activity are provided. The original documents and authentication methods are especially useful in the context of a process that involves digital imaging and truncation of the original document, e.g., in a Check 21 check clearance process. To this end, the documents may comprise bearer information, such as bank check information. It should be noted, however, that the present inventions, in their broadest aspects, should not be necessarily limited to applications involving a bank check clearing process, and may extend to other security document applications.

In accordance with a first aspect of the present inventions, an original document comprises a printable substrate, a first security feature that forms a latent copy-void warning message that visually appears on an electronically printed reproduction of the document original, and a second security feature that forms a latent validation message that visually appears on a digital reproduction of the document original. Although the present inventions should not be so limited in their broadest aspects, this arrangement allows a possessor of a document to quickly identify it as a counterfeit by virtue of the presence of the copy-void warning message on the printed document reproduction, and allows a possessor of a digital document reproduction to quickly identify it as an authentic digital image of the document original by virtue of the nature and presence of the validation message. The second security feature is at least partially embedded, and can be completely embedded, within the first security feature. In this manner, a criminal who attempts to circumvent the first security feature by removing the latent copy-void warning message, will inadvertently remove the latent validation message. As a result, any document generated from such fraudulent activity will not contain the validation message, thereby indicating to a possessor of a digital reproduction of a document that it was not generated from the document original.

In accordance with a second aspect of the present inventions, another original document comprises a printable substrate, a first plurality of nano-structures for forming a latent copy-void warning message that visually appears on an electronically printed reproduction of the document original, and a second plurality of nano-structures for forming a latent validation message that visually appears on a digital reproduction of the document original. The first plurality of nano-structures may activate the latent copy-void warning message on the printed document reproduction by trapping printing matter during the reproduction process, and the second plurality of nano-structures may activate the latent validation message on the digital document reproduction by, e.g., forming a pixel pattern during the imaging process. In order to facilitate trapping printing matter or creation of the pixel pattern, the nano-structures are preferably as small as possible, e.g., less than two-point in size, and preferably, less than one-point in size. The second plurality of nano-structures is arranged at least partially, and may be completely, within the first plurality of nano-structures, e.g., to prevent a criminal from circumventing the copy-void warning message. Thus, it can be appreciated that this original document may be advantageous in the same manner as the first original document described above, with the exception that nano-structures are used to form the latent messages.

To provide further security to the previously described original documents, another security feature can be used to form another latent validation message that visually appears on the document originals. In this case, the two latent validation messages complement each other well, since a validation message is guaranteed to appear on both the document original and the digital document reproduction, even though validation messages that are designed to visually appear on the document original typically do not survive a digital conversion process, and validation messages that are designed to visually appear in a digital document reproduction typically do appear on the document original. In one embodiment, the additional latent validation message is formed by arranging thermochromic ink on the substrate. The thermochromic ink has a visual density, which when thermally heated, causes the additional validation message to appear on the document original. The thermochromic ink may be arranged on the substrate at least partially within the first plurality of nano-structures or otherwise within the first security feature, e.g., to prevent circumvention of the latent copy-void warning message. In order to facilitate hiding of the latent copy-void warning message and the additional latent validation message on the document original during normal viewing conditions, a camouflage layer may spatially overlap the first and third security features. The camouflage layer may spatially overlap the first validation message as well; however, because the first validation message is at least partially disposed within the copy-void warning message, the first validation message may be relatively small, thereby obviating the need to hide it.

In accordance with a third aspect of the present inventions, an authentication method comprises creating a digital reproduction of either of the previously described document originals and examining the digital document reproduction for the validation message, the appearance of which verifies the authenticity of the document original. The examination can be accomplished manually, but may also be accomplished automatically in order to facilitate quick and efficient detection of counterfeit, or otherwise altered, documents.

In accordance with a fourth aspect of the present inventions, still another original document comprises a printable substrate, and a plurality of nano-structures for forming a first latent message that visually appears on a reproduction of the document original (e.g., an electronically printed reproduction or digital reproduction of the document original), and for forming a second latent validation message that visually appears at least partially within the copy-void warning message on the document reproduction. The nano-structures may operate in the same manner described above. This original document may be advantageous in that two messages may generally occupy the same region on the document original. If the latent messages are intended to be part of a security technology, their confinement to a single region not only saves space on the document original, but also requires the document original to be conveniently authenticated by examining a single region on the document. An additional latent message that appears on the document original (e.g., using thermochromic ink) and a camouflage layer can be optionally applied to the document original in a spatially overlapping manner with the first and second latent messages.

In accordance with a fifth aspect of the present inventions, yet another original document comprises a printable substrate, a first nano-pattern, and a second nano-pattern. The first nano-pattern is configured for trapping printing matter on an electronically printed reproduction of the document, such that the first nano-pattern forms a first latent message that visually appears on the printed document reproduction. The second nano-pattern is at least partially within, and optionally completely surrounded by, the first nano-pattern, and is configured to form a pixel pattern on a digital reproduction of the document original, such that the second nano-pattern forms a second different latent message that visually appears on the digital document reproduction. The first nano-pattern may form a pixel pattern on the digital document reproduction that differs from the pixel pattern created by the second nano-pattern, e.g., to provide contrast to the second latent message. An additional latent message that appears on the document original (e.g., using thermochromic ink) and a camouflage layer can be optionally applied to the document original in a spatially overlapping manner with the first and second latent messages.

In accordance with a sixth aspect of the present inventions, a method of authenticating a digital reproduction of an original document is provided. The document original carries nano-structures that form a latent message, such as a validation message. The nano-structures may operate as previously described above. The method comprises creating a digital reproduction of the document original, examining the digital document reproduction, which can be done manually or automatically, and authenticating the digital document reproduction (e.g., whether the document original has been counterfeited or altered) based on the examination. If the latent message is a validation message, its identification may be used to conveniently authenticate the digital document reproduction. The nano-structures may form an additional latent message, such as a copy-void warning message, in which case, the method may further comprise confirming that the other latent message does not appear on the document original. The first latent message may be at least partially embedded within the other latent message. In an optional method, the document original may comprise thermochromic ink that forms another latent message, in which case, heat can be applied to the document original to cause the other message to appear on the document original. This additional message can then be identified on the document original.

In accordance with a seventh aspect of the present inventions, a method of authenticating a digital reproduction of an original document is provided. The document original carries nano-structures that form a latent message, such as a validation message. The method comprises creating a digital reproduction of the document original to form a pixel pattern representing the latent message, comparing the pixel pattern with a reference pixel pattern, and authenticating the digital document reproduction based on the pixel pattern comparison. The pixel pattern comparison may be accomplished manually, but preferably is accomplished automatically in order to facilitate the authentication process. In one method, the reference pixel pattern is obtained by creating a digital reproduction of a known sample of the document original. In this case, the digital document representation has the same resolution as the digital sample representation. The nano-structures may be optionally varied, so that any pixel pattern differences between the digital document reproduction and the digital sample reproduction is accentuated. The method may further comprise examining the digital document reproduction for the appearance of the validation message.

In accordance with an eighth aspect of the present inventions, an original document is provided. The document comprises a printable substrate, a latent message having a visual density configured to change in the presence of an environmental condition to activate the latent message on the document original, and a normally visible message having a visual density configured to change in the presence of the environmental condition (e.g., a thermal condition involving an increase in temperature) to deactivate the normally visible message. The latent message and the normally visible message spatially overlap with each other, so that, e.g., the messages can be confined to a single region. For example, the normally visible message can be printed over the latent message, or the latent message can be printed over the normally visible message. Because only one of the messages is intended to be activated at a given time, they can co-exist. In one embodiment, the normally visible message comprises bearer information, e.g., bank check bearer information. In another embodiment, the normally visible message occupies a region defining a bearer field, e.g., a signature field. In an optional embodiment, the document original comprises another latent message configured to visually appear on an electronically printed reproduction and/or digital reproduction of the document original. In this case, the other latent message and normally visible message may spatially overlap. If the environmental condition that deactivates the normally visible message is an increase in temperature, which would typically occur during an electronic printing/digital reproducing process, the normally visible message will not appear on the printed document reproduction and/or digital document reproduction, so that the other latent message is not obscured.

In accordance with a ninth aspect of the present inventions, an original document is provided. The document comprises a printable substrate, a background, and first and second messages. The first message and background have visual densities that are configured to be substantially similar in the absence of an environmental condition (e.g., a thermal condition involving an increase in temperature) to deactivate the first message on the document original, and configured to be substantially different in the presence of the environmental condition to activate the first message on the document original. In contrast, the second message and background have visual densities that are configured to be substantially similar in the presence of an environmental condition to activate the second message on the document original, and configured to be substantially different in the absence of the environmental condition to deactivate the second message on the document original. The first and second messages spatially overlap with each other, so that, e.g., the messages can be confined to a single region. As previously discussed, one of the messages can comprise bearer information, such as bank check bearer information, and/or can occupy a region defining a bearer field, e.g., a signature field. The document original may comprise other latent messages configured to visually appear on an electronically printed reproduction and/or digital reproduction of the document original without being obscured by the second message, which may deactivate in the presence of an increased temperature.

In accordance with a tenth aspect of the present inventions, an original document is provided. The document original comprises a printable substrate, a latent message, and a normally visible message. The latent message has a visual density configured to change in the presence of an environmental condition to activate the latent message on the document original. In contrast, the normally visible message has a visual density configured to camouflage the latent message on the document original in the absence of the environmental condition, and configured to change in the presence of the environmental condition to facilitate visualization of the activated latent message on the document original. Thus, it can be appreciated that the normally visible message not only serves to convey additional information, it also serves to hide the deactivated latent message. The document original may comprise other latent messages configured to visually appear on an electronically printed reproduction and/or digital reproduction of the document original, in which case, the visual density of the normally visible message can be configured to camouflage the other latent message on the document original in the absence of the environmental condition, and configured to change in the presence of the environmental condition to facilitate visualization of the activated latent message on the printed document reproduction and/or digital document reproduction.

Other advantages and features of the present inventions will become apparent from consideration of the following description taken in conjunction with the accompanying drawings.

### BRIEF DESCRIPTION OF THE DRAWINGS

The drawings illustrate the design and utility of preferred embodiment(s) of the present invention, in which similar elements are referred to by common reference numerals. In order to better appreciate the advantages and objects of the present invention, reference should be made to the accompanying drawings that illustrate the preferred embodiment(s). The drawings depict only an embodiment(s) of the invention, and should not be taken as limiting its scope. With this caveat, the preferred embodiment(s) will be described and explained with additional specificity and detail through the use of the accompanying drawings in which:

FIG. 1 is a plan view of the front surface of a counterfeit-resistant document original constructed in accordance with one preferred embodiment of the present invention;

FIG. 2 is a plan view of the rear surface of the document original of FIG. 1;

FIG. 3 is a plan view of an electronically printed reproduction of the document original of FIG. 1, particularly showing the activation of a latent copy-void warning message that occurs when the document original is electronically copied;

FIG. 4 is a plan view of digital reproduction of the document original of FIG. 1, particularly showing the activation of a latent validation message that occurs when the document original is digitally imaged;

FIG. 5 is a plan view of the document original of FIG. 1, particularly showing the activation of a latent validation message when the heat is applied to the document original;

FIG. 6 is a plan view of the front surface of a counterfeit-resistant document original constructed in accordance with another preferred embodiment of the present invention;

FIG. 7 is a magnified view of a document verification region carried by the document original of FIG. 1;

FIG. 8 is a magnified view of an electronically printed reproduction of the document verification region of FIG. 7, particularly showing the activation of the latent copy-void warning message and latent validation message illustrated in FIGS. 2 and 3;

FIG. 9 is a magnified view of a digital reproduction of the document verification region of FIG. 7, particularly showing the activation of the latent copy-void warning message and latent validation message illustrated in FIGS. 2 and 3;

FIG. 10 is a magnified view of the document verification region of FIG. 7, particularly showing the activation of the latent validation message illustrated in FIG. 4;

FIG. 11 is a magnified view of a low-resolution digital reproduction of the nano-pattern that forms the letter “P” in the latent copy-void warning message of FIG. 7;

FIG. 12 is a magnified view of a low-resolution digital reproduction of a color copy of the nano-pattern that forms the letter “P” in the latent copy-void warning message of FIG. 7; and

FIG. 13 is a magnified view of a low-resolution digital reproduction of a high-resolution digital scan of the nano-pattern that forms the letter “P” in the latent copy-void warning message of FIG. 7.

### DETAILED DESCRIPTION OF THE PREFERRED EMBODIMENTS

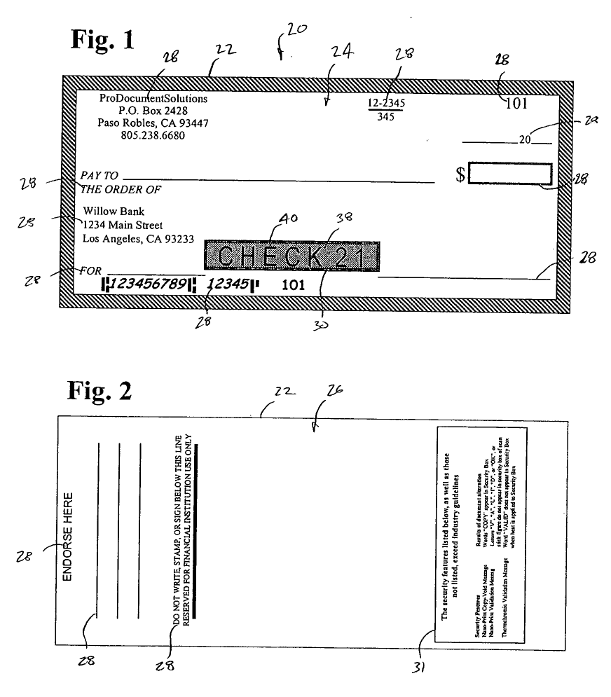

Referring to FIGS. 1 and 2, a preferred embodiment of a counterfeit-resistant document original 20 (in this case, a bank check) will now be described in detail. The document original 20 generally comprises a substrate 22 having a front surface 24 (FIG. 1) and a rear surface 26 (FIG. 2), bearer information 28 printed on the front and rear surfaces 24, 26 of the document original 20, and a document verification region 30 carried by the front surface 24 of the document original 20, and a security legend 31 carried by the rear surface 26 of the document original 20. Alternatively, the document verification region 30 can be carried by the rear surface 26 of the document original 20.

The substrate 22 is generally planar and is preferably of paper stock, although any material suitable for printing may be used without departing from the scope of the invention. The dimensions of the substrate 22 preferably comport with the requirements that any standard imposes on the document class in which the document original 20 falls. For example, in the case of a bank check, the substrate 22 should be 6″×2¾″.

The bearer information 26 takes the form of alphanumeric characters and other markings, such as lines and boxes, that are printed on the front surface of the substrate 22 and defines the nature of the document original 20. For example, the illustrated document original 20 takes the form of a bank check, in which case, the bearer information 26 is printed in standardized check fields on the front substrate surface 24, e.g., payor information, check number, payee identification, date, numerical and textual payment amounts, bank information, signature line, MICR line, etc, and on the rear substrate surface 24, e.g., endorsement information and directions. The security legend 31 provides instructions and information regarding the security features contained within the document verification region 30.

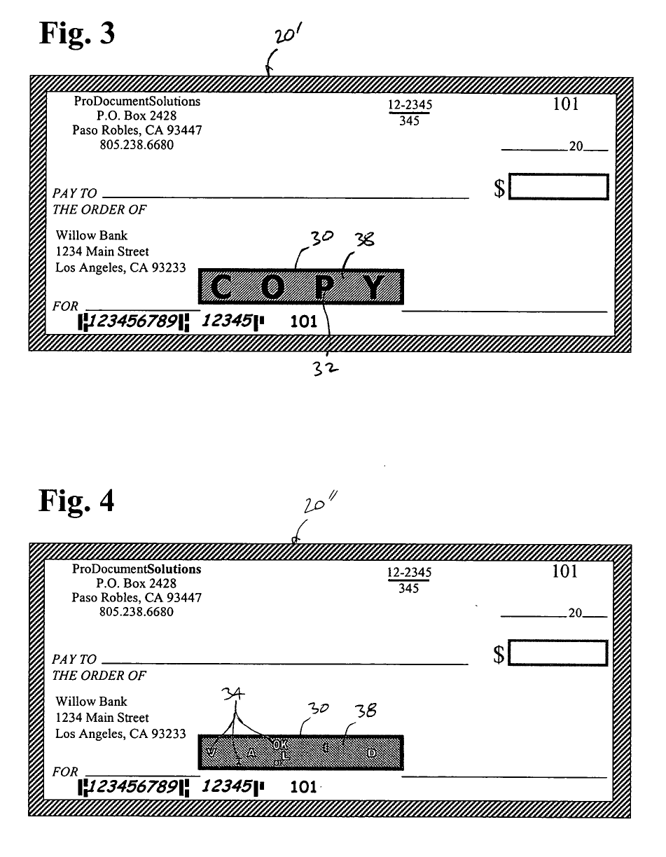

The document verification region 30 comprises several security features that deter, or otherwise allow detection, of fraudulent activity involving the document original 20. In the illustrated embodiment, three security features are provided: (1) a first security feature in the form of a latent copy-void warning message 32, which can be activated to appear on a printed reproduction 20′ when the document original 20 is electronically copied (either directly using a standard copying machine or by digitally imaging the document original and then printing the digital scan) (FIG. 3); (2) a second security feature in the form of a latent validation message 34, which can be activated on a digital document reproduction 20″ when the document original 20 is digitally imaged (FIG. 4); and (3) a third security feature in the form of a latent validation message 36 that can be activated on the document original 20 itself in the presence of an environmental condition, and in this case, the application of heat (FIG. 5). As will be described in further detail below, additional security features, besides those that generate latent messages, may be carried by the substrate 22 to deter or otherwise facilitate detection of fraudulent activity. For the purposes of this specification, the digital document reproduction 20″ can be considered the digital information in which the document 20 original has been digitally converted or can be considered the image of the digitally converted document original 20 as it appears on a monitor.

The document verification region 30 also comprises a background 38 that serves to hide the inactivated latent messages, while providing an effective contrast to the activated latent messages. The document verification region 30 also comprises a camouflage layer 40 disposed over the latent messages 32, 34, and 36 to facilitate hiding of these messages on the document original 20 during normal viewing conditions. It can be appreciated that the use of a single document verification region 30 facilitates the authentication process in that an observer need only view one area of the document original 20, printed document reproduction 20′, or digital document reproduction 20″ to determine authenticity. As will be described in further detail below, the latent messages combine within the verification region 30 to uniquely thwart attempts to counterfeit the document original 20.

It should be noted that the latent messages can take the form of any textual or symbolic message capable of conveying information to any person viewing the message. For example, the copy-void warning message 32 illustrated in FIG. 3 is a textual message, and in particular, the word “COPY” regularly spaced along the document verification region 30 in large letters. The validation message 34 illustrated in FIG. 4 actually comprises several message components of textual and symbolic form. In particular, the validation message 34 comprises the letters “V”, “A”, “L”, “I”, “D” in “negative” form (i.e., the outline of the letters are dark and the centers of the letters are light), which are irregularly spaced along the document verification region 30 to spell out the word “VALID.” The validation message 34 also comprises the word “OK,” which appears in both a “positive” (i.e., the entirety of the letters are dark) and “negative” form, and a stick-figure, which appears in positive form. It should be noted that the components of the validation message 34 will actually be much smaller than they appear in FIG. 4, so that they can be incorporated and hidden within the copy-void warning message 32, as will be described in further detail below. For purpose of illustration, however, the size of these components has been exaggerated. The validation message 36 illustrated in FIG. 5 comprises a textual message, and in particular, the word “VALID” regularly spaced along the document verification region 30 in large letters. Whether designed to be noticed by a casual observer or an observer with a trained eye, each of the latent messages 32, 34, 36 can be detected visually in that an observer may recognize the messages either with the unaided eye or with a magnification device, such as a simple magnification loupe, thereby enabling quick verification of the authenticity of the document original 20 or digital document reproduction 20″.

It can be appreciated that the latent messages 32, 34, and 36 should not be limited to those respectively illustrated in FIGS. 3-5. In particular, the copy-void warning message 32 can take the form of any message that indicates to a casual observer that the document that he or she is currently viewing is a printed document reproduction 20′. The validation message 34 can take the form of any message that indicates to an observer that the image that he or she is currently viewing is the digital document reproduction 20″. It should be noted that because the validation message 34 is designed to be hidden within the copy-void warning message 32, it is possible for it to be unnoticeable to a casual observer. Rather, it is more likely to be noticed by an observer with a trained eye (i.e., an observer who has priori knowledge of the nature of the validation message 34). The validation message 36 can take the form of any message that indicates to a casual observer that the document that he or she is currently viewing is the document original 20. Although the validation message 36 is shown embedded within the copy-void warning message 32, alternatively, the validation message 36, or a portion thereof, may be located outside of the copy-void warning message 32. For example, the letters “C”, “O”, “P”, and “Y” of the copy-void warning message 32 may be interleaved between the letters “V”, “A”, “L”, “I”, and “D” of the validation message 36. In this manner, the clarity of the activated copy-void warning message 32 will not be adversely affected by the presence of the validation message 36.

The use of three latent messages provides a robust means for preventing, or otherwise discouraging, counterfeiting of the document original 20 in view of the challenges posed by the Check 21 process (or any process that involves truncating an document original, i.e., digitally reproducing a document original and then transmitting the digital document reproduction in lieu of the discarded document original).

In particular, in such a process, it is desirable to allow an observer to verify the authenticity of a check, so that a counterfeit check can be detected as quickly as possible, and more preferably, at the point of presentment of the counterfeit check to prevent the worthless check from ever entering the check clearance system. However, a typical security feature that is designed to authenticate a document original with a latent validation message will not survive the digital conversion process, and will thus be useless to a great extent after the document original has been truncated. Thus, two dedicated security features are used to perform the respective authentication functions.

To this end, the latent validation message 34 is specifically designed to allow an observer (such as an investigator) to quickly verify that a digital document reproduction is in fact a digital document reproduction 20″ generated from the document original 20, thereby providing a means for determining whether a truncated document is the document original 20. That is, if the validation message 34 is not duplicated in exactness during the counterfeiting process, it will not appear correctly on the region of the digital document reproduction corresponding to the document verification region 30 of the document original 20, thereby providing an indication that the document from which the digital reproduction was generated is a printed document reproduction 20′, and thus, most likely counterfeit. It should be noted that the latent validation message 34 may not only be detected visually by an observer, but can also be automatically detected using a machine verification process, such as via specialized hardware and software installed on a computer. Such automatic verification can be especially advantageous, since the digital document reproductions 20″ are already being handled by computers, thereby providing a means for instantaneously detecting counterfeit documents at the point where the counterfeit documents are digitally imaged.

In contrast, the latent validation message 36 is specifically designed to interact with and allow an observer (such as a bank teller or a store owner) to verify the authenticity of the document original 20. That is, if the validation message 36 is not duplicated during the counterfeiting process, it will not appear on the region of the counterfeited document corresponding to the document verification region 30 of the document original 20, thereby providing an indication that the document is not the document original 20, but is instead a counterfeit.

It is also desirable in a Check 21 process to enable an untrained observer without priori knowledge of the document verification region 30 to immediately detect a counterfeit document during normal human viewing conditions. That is, although a latent validation message, such as the validation message 36, may enable an observer to detect a counterfeit document by detecting the absence of the latent validation message, the nature of these types of validation security features typically require the observer to perform an additional step, such as rubbing or otherwise heating the security feature, viewing the document at a particular angle, viewing the document under certain lighting conditions, etc. However, an observer may not be aware of this requirement, or otherwise fail to perform this additional step, in which case, the validation message will not facilitate detection of a counterfeit document.

In contrast, the use of the latent copy-void warning message 32 facilitates immediate detection of the printed document reproduction 20′. That is, if the document original 20 is electronically copied as part of a counterfeiting operation (either directly using a standard copying machine or by digitally imaging the document original and then printing the document image), the latent copy-void warning message 32 will appear on the region of the printed document reproduction 20′ corresponding to the document verification region 30 of the document original 20, which can then be visually detected by a human observer to provide a clear indication that the document possessed by an observer (e.g., a store owner or bank teller) is indeed the printed document reproduction 20′, and thus counterfeit. Thus, the copy-void warning message 32 enables immediate detection of a counterfeit document under normal viewing conditions and without requiring the human observer to perform an additional step, which he or she may not otherwise be aware of.

It can be appreciated from the foregoing discussion that the latent messages 32, 34, 36 work well together in that, although it may be possible for a counterfeiter to circumvent one of these security features, it is very difficult to circumvent all of them. For example, because the latent validation message 34 is designed to survive a digital conversion process, it will likewise survive a digital scanning process. This allows the validation message 34 to be circumvented by scanning the document original 20 at a high resolution, generating a high resolution offset lithography printing plate, and then utilizing an offset lithography printing press for printing it out to generate a printed document reproduction that contains the activated validation message 34. If this printed document reproduction is later digitally imaged (e.g., by a bank), the resulting digital document reproduction will include the validation message 34. In this case, it may appear that the digital image generated during the document truncation process was generated directly from the document original 20 based on a mere examination of the validation message 34. Thus, it may be difficult to visually determine whether a digital image was generated from a direct scan of the document original 20 or a counterfeit of a document original 20 based merely on the presence of the latent validation message 34 on a digital document reproduction.

However, the safeguards provided by the other latent messages 32, 36 prior to document truncation ensure, that at the least, the digital document reproduction was not generated from a printed document reproduction 20′. That is, the visualization of no validation message 36, or more likely, the visualization of the stark copy-void warning message 32, on a document prior to imaging will alert the observer that the document is not the document original 20, but rather a counterfeit. In this case, the observer will not digitally image the document. Thus, the fact that a digital document reproduction with a validation message 34 exists provides a strong indication that it was not generated from a direct scan of a document copy.

The validation message 34 derives much of its benefit by enabling detection of the digital document reproduction that was generated from a counterfeit document on which the latent copy-void warning message 32 has been circumvented. In particular, the latent copy-void warning message 32 can be circumvented by taking a high-resolution scan of the document original 20 and digitally obliterating or otherwise manipulating the latent copy-void warning message 32, such that it will not appear on the printed document reproduction 20′. Significantly, however, the latent validation message 34 is embedded within the latent copy-void warning message 32, thereby making it more difficult to counterfeit the document original 20 via manipulation of the document verification region 30. That is, when the latent copy-void warning message 32 is obliterated or manipulated, the latent validation message 34 will likewise be obliterated or manipulated, such that it will not appear on an image of the counterfeited document. Thus, even if the latent copy-void warning message 32 has been circumvented, the counterfeit can be detected subsequent to document truncation. Of course, the latent validation message 36 can still be relied on to detect a counterfeit prior to document truncation by indicating to an observer that a document is not the document original 20 in the absence of the latent validation message 36.

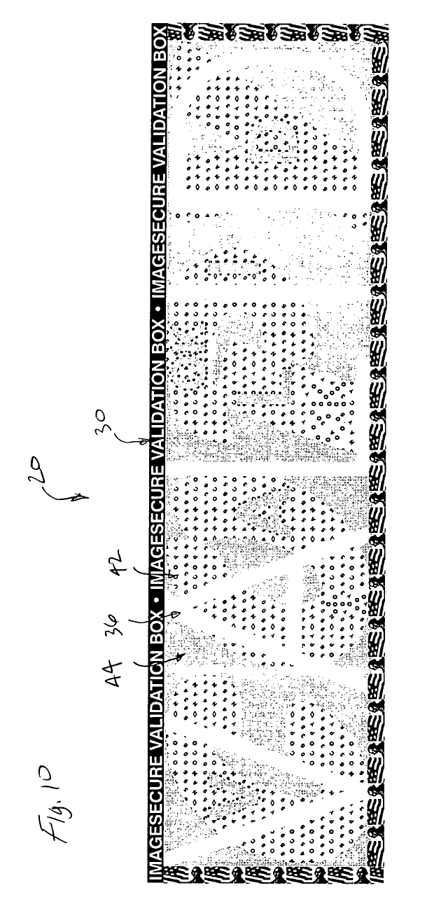

It should be noted that although the latent copy-void warning message 32 and latent validation message 34 are illustrated in FIGS. 3 and 4 as being separately formed on the respective printed document reproduction 20′ and digital document reproduction 20″, the similarities in digital imaging and electronic copying of documents makes it difficult to cause the copy-void warning message 32 to appear on the printed document reproduction 20′ without also appearing on the digital document reproduction 20″, and likewise makes it difficult to cause the validation message 34 to appear on the digital document reproduction 20″, without appearing on the printed document reproduction 20′. As such, it will typically be the case that both the latent copy-void warning message 32 and latent validation message 34 are formed on each of the printed document reproduction 20′ and digital document reproduction 20″, with the latent copy-void warning message 32 serving as a background to the latent validation message 34, as will be described and illustrated in FIGS. 8 and 9 below. In this case, it can be appreciated that a digital image of the printed document reproduction 20′ may look very similar to a valid digital document reproduction 20″, and thus, outside of a comprehensive pixel pattern analysis, it would be difficult to tell one from the other. As described above, however, in a controlled authentication process with an informed inspector, the printed document reproduction 20′ would most likely be detected as a counterfeit before the digital conversion process.

Notably, if the latent validation message 34 also visually appears to an observer of the printed document reproduction 20′, as illustrated in FIG. 8, it, by itself, has the potential to falsely indicate to an observer that the printed document reproduction 20′ is authentic. However, because the size of the copy-void warning message 32 is much greater than that of the validation message 34, which may be difficult to recognize to the untrained eye, the existence of the copy-void warning message 32 will readily indicate to the observer that the printed document reproduction 20′ is, in fact, a counterfeit. The observer may also be given prior knowledge that as long as the copy-void warning message 32 appears on a document prior to the truncation process (e.g., the document is not a substitute check), regardless of the presence of the validation message 34, the document is not authentic. At the very least, the conflicting messages provided by the presence of both the copy-void warning message 32 and validation message 34 will alert the observer that the document may not be authentic, and further examination of the document is needed.

Thus, it can be appreciated that the document verification region 30 provides a robust means of verifying the authenticity of the physical document original 20, as well as the authenticity of the digital document reproduction 20″ (i.e., that the digital image was generated from a direct digital scan of the document original 20). It can also be appreciated that the document verification region 30 provides a means for transferring liability downstream in the check clearing process. That is, the Payor (i.e., the authorized drafter of the checks) can be assured that he or she will not be liable for any unauthorized debits of his or her bank account due to fraudulent activity. Also, the converting bank (i.e., the first bank that transmits a digital image of the check in lieu of the physical check) will be assured that liability will be passed to the next bank in the check clearing process, since the latent validation message 34 will survive, and will in fact be activated by, the digital conversion process.

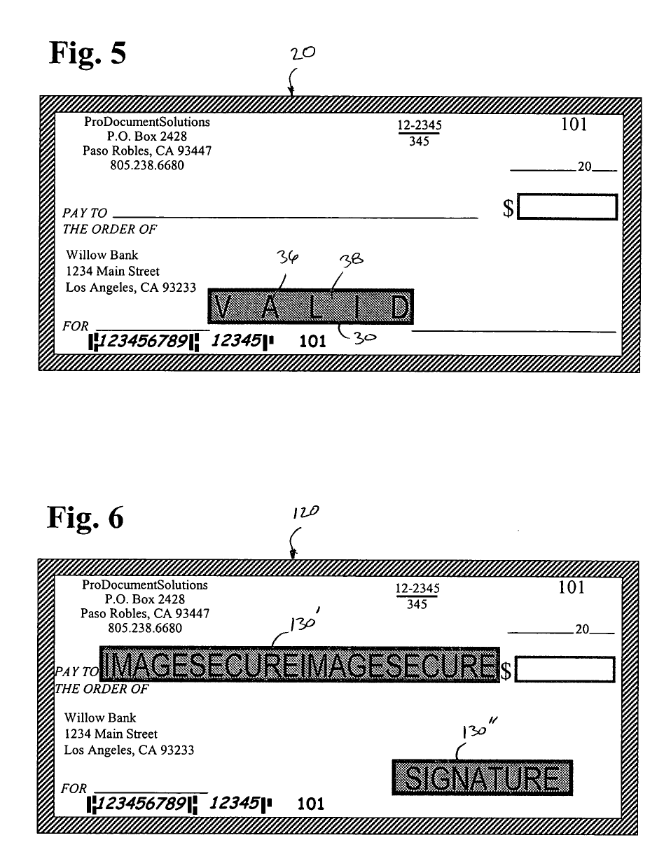

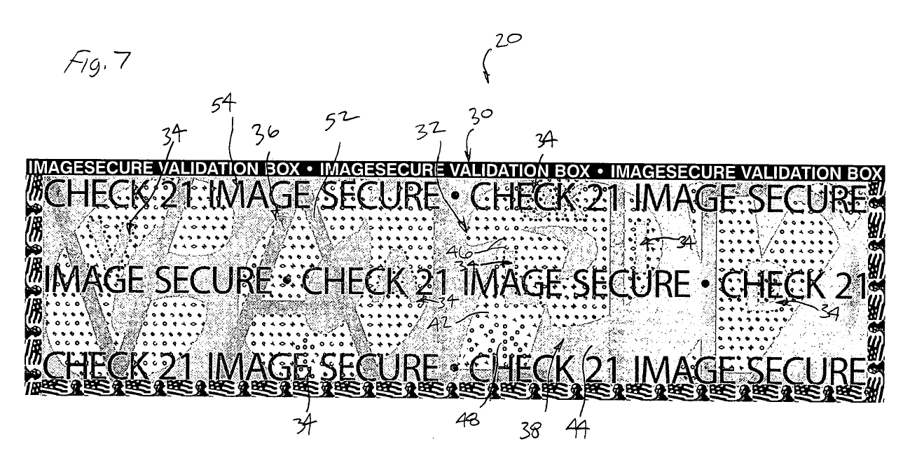

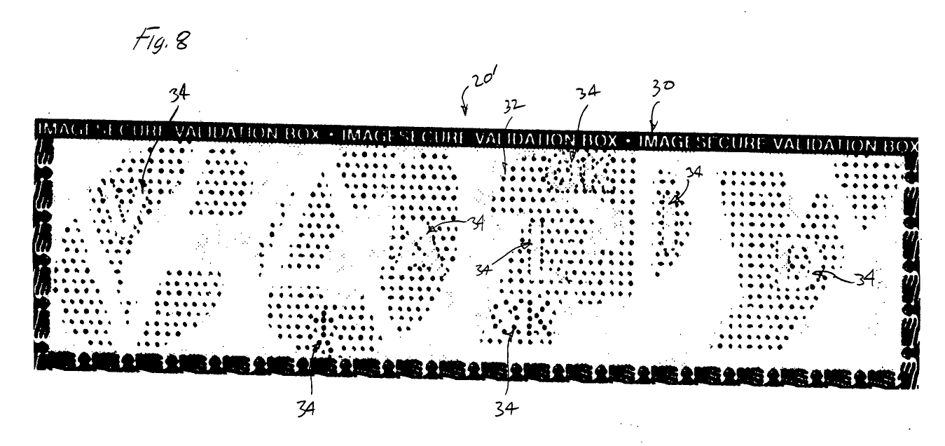

Although the document verification region 30 of the document original 20 is illustrated and described as being separate from the bearer information fields 28, the document verification region 30 can be advantageously incorporated into bearer information fields 28 to prevent fraudulent activity other than counterfeiting. For example, FIG. 6 illustrates a fraud-resistant document 120, which is similar to the document original 20, with the exception that it comprises a document verification region 130 that resides within one or more bearer information fields 28, and in particular, document verification region 130′ and 130″ that reside within the textual payment amount and signature line. In this manner, if a criminal attempts to modify the payment amount and signature written into these fields by the document owner, the latent validation messages will most likely be obliterated or, at the least altered, thereby, upon close inspection, alerting a person in possession of the document 120 of possible fraudulent activity. Thus, the document original 120 or a digital representation of the document original 120 may be authenticated by both determining whether they have been counterfeited and whether they have been fraudulently altered.

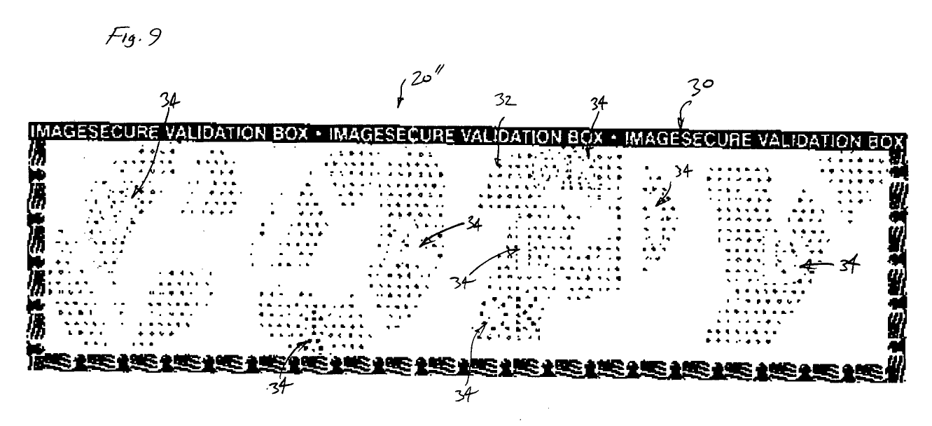

Referring now to FIGS. 7-10, the security features of the document verification region 30 will be described in greater detail. Referring first to FIGS. 7 and 8, the latent copy-void warning message 32 comprises a nano-pattern 42 and the background 38 comprises a contrasting background pattern 44. In the preferred embodiment, the nano-pattern 42 and background pattern 44 are printed directly onto the substrate 22, with the nano-pattern 42 occupying a region that defines the latent copy-void warning message 32 and the background pattern 44 occupying a region surrounding the copy-void warning message 32. The nano-pattern 42 and background pattern 44 are designed, such that the contrast of the nano-pattern 42 relative to the background pattern 44 on the document original 20 substantially increases on a digitally printed document reproduction 20′ in order to activate the latent copy-void warning message 32. Preferably, the nano-pattern 42 exhibits a visual density that is similar to that of the background pattern 44 on the document original 20 (FIG. 7), so that a casual observer cannot readily recognize the copy-void warning message 32, but exhibits a visual density that is substantially different from that of the background pattern 44 on the printed document reproduction 20′ (FIG. 8), so that a casual observer can readily recognize the copy-void warning message 32.

The visual density similarity between the nano-pattern 42 and background pattern 44 on the document original 20 is effected by printing both patterns using dots, lines, or other suitable element markings. The line resolution value (i.e., number of lines per inch), tonal screen value (i.e., percentage of ink coverage), and element size used to form the nano-pattern 42 and background pattern 44 are adjusted, such that they exhibit substantially similar visual densities on the document original 20. For example, the line resolution value, element size, and tonal screen values for each of the nano-pattern 42 and background pattern 44 can be printed to exhibit a visual 3% value. Preferably, to facilitate the contrast between the nano-pattern 42 and background pattern 44 on the printed document reproduction 20′, the nano-pattern 42 has a relatively low line resolution value (e.g., 50LPI) and relatively large element size, whereas the background pattern 44 has a relatively high line resolution value (e.g., 133LPI) and relatively small element size. It should be noted, however, that the nano-pattern 42 and background pattern 44 can have similar line resolution values and element sizes without straying from the principles taught by the present invention.

The visual density disparity between the nano-pattern 42 and background pattern 44 exhibited on the printed document reproduction 20′ is effected by the darkening of the nano-pattern 32 when copied. Specifically, the nano-pattern 42 takes advantage of the fundamental limitations of optical scanning digital systems and toner or ink jet output devices, which cannot reproduce very minute, fine detailed nano-printing of certain rectilinear or curvilinear patterns. That is, the nano-pattern 42 is designed, such that ink or toner traps are formed within the nano-pattern 42. These ink or toner traps fill and darken when ink jet or toner printed. As a result, the ink or toner traps cause the nano-pattern 42 to exhibit an increased visual density when the document original 20 is copied.

To this end, the nano-pattern 42 comprises a plurality of nano-structures 46 that are designed such that traps are formed within, around, and/or between adjacent nano-structures 46. To facilitate the formation of the ink or toner traps, the nano-structures 46 are preferably miniaturized, e.g., less than two-point, and preferably less than one-point, in size. In general, the more traps that a particular nano-structure 46 forms, the more efficient the nano-structure 46 is in activating the latent copy-void warning message 32 when electronically copied.

Although the visual density of the nano-pattern 42 substantially increases on the printed document reproduction 20′, the background pattern 44, on the other hand, is designed to minimally print, or at a minimum, is normally printed. That is, the background pattern 44 is designed, such that ink or toner traps are not formed therein. In this respect, the background pattern 44 is similar to typical patterns that are printed on original documents. As a result, the visual density of the background pattern 44 does not substantially increase on the printed document reproduction 20′, and in fact, may completely disappear on the printed document reproduction 20′ if the background pattern 44 is fine enough. The disappearance of the background pattern 44 not only has the advantage of enhancing the contrast between the copy-void warning message 32 and background 38 on the printed document reproduction 20′, it also reduces the file size of the digital document reproduction 20″ when the document original 20 is digitally imaged. Thus, the nano-pattern 42 and background pattern 44 are designed, such that the respective patterns exhibit substantially different visual densities on the printed document reproduction 20′. The disparate visual densities exhibited by the respective nano-pattern 42 and background pattern 44, when electronically copied, activate the latent copy-void warning message 32 such that it visually appears on the printed document reproduction 20′, as illustrated in FIG. 8.

In the embodiment illustrated in FIG. 7, the nano-structures 46 take the form of alpha-numerical characters, and in particular, diagonally oriented letters “N”, “A”, “N”, “O”, “C”, “O”, “P”, and “Y”, which spell out the repeating word “NANOCOPY”, as well as a series of diagonally oriented numbers. It should be noted, however, that any nano-structures composed of rectilinear and/or curvilinear elements (e.g., x's, o's, polygons, etc.) that are coordinated to form miniature ink or toner traps can be used for the nano-pattern 42 to activate the latent copy-void warning message 32. However, the use of alphanumerical characters provides a further level of security in that additional information can be conveyed to the observer of the document original 20. That is, the alphanumerical characters may be arranged to form a separate message, such as the indicia indicting validity, date printed, customer's name, and/or secret numerical code, within the message 32. With respect to the embodiment illustrated in FIG. 7, an observer in possession of the document original 20, knowing that the document original 20 comprises the repeating words “NANOCOPY” in nano-printing, can review the document original 20 with a magnification aid, such as a magnification loupe. If the repeating word “NANOCOPY” appears in the nano-pattern 42 on the document original 20, its authenticity is ensured. In contrast, if the repeating word “NANOCOPY” has been obliterated (shown in FIG. 8), which will typically occur during the electronic copying process, an observer will know that he or she is in possession of the printed document reproduction 20′. Besides alphanumerical characters, the nano-structures 46 can also take the form of pictures or symbols that can be identified by an observer to authenticate the original document.

Further details regarding the use of nano-characters to provide security features to document originals are disclosed in U.S. patent application Ser. No. 09/621,325, which is expressly incorporated herein by reference.

Referring now to FIGS. 7 and 9, the components of the latent validation message 34 comprise nano-patterns 48, which are embedded within the nano-pattern 42 of the latent copy-void warning message 32. In particular, certain regions within the copy-void nano-pattern 42 are modulated or replaced with the validation nano-patterns 48. The validation nano-patterns 48, along with the copy-void nano-pattern 42, are designed, such that the contrast between the validation nano-patterns 48 relative to the copy-void nano-pattern 42 on the document original 20 substantially increases on the digital document reproduction 20″ in order to activate the components of the latent validation message 34. Preferably, the validation nano-patterns 48 exhibit visual densities that are similar to that of the copy-void nano-pattern 42 on the document original 20 (FIG. 7), so that a casual observer cannot readily recognize the validation messages 34, but exhibit visual densities that are substantially different from that of the copy-void nano-pattern 42 on the digital document reproduction 20″ (FIG. 9), so that a casual observer can readily recognize the validation messages 34. In essence, the copy-void nano-pattern 42 serves as a background to the validation nano-patterns 48 to activate the components of the latent validation message 34 in much the same manner as the previously described background pattern 44 serves as a background to the copy-void nano-pattern 42 to activate the latent copy-void warning message 32.

As with the copy-void nano-pattern 42 and background pattern 44, visual density similarity between the validation nano-patterns 48 and the copy-void nano-pattern 42 on the document original 20 is effected by printing both patterns using dots, lines, or other suitable element markings. The line resolution value (i.e., number of lines per inch), tonal screen value (i.e., percentage of ink coverage), and element size used to form the nano-patterns 42, 28 are adjusted, such that they exhibit substantially similar visual densities on the document original 20. Notably, because the validation message 34 is relatively small in comparison to the copy-void warning message 32, and thus, not as noticeable, the visual densities between the respective nano-patterns 42, 48 may be less similar than the visual densities between the nano-pattern 42 and the background pattern 44.

The visual density disparity between the nano-patterns 42, 48 exhibited on the digital document reproduction 20″ is effected by the darkening of nano-patterns 42, 48 relative to each other when digitally imaged. Specifically, the nano-patterns 42, 48 take advantage of the fundamental limitations of digital scanning systems, which work by pixelizing the document images (i.e., the analog images of the document are transformed into discrete pixels and paxels (i.e., 0.010″×0.010″ clusters of pixels)). Thus, typical digital scanning systems, especially the low-resolution scanning systems that will be used by banks to transform original checks into digital images, cannot reproduce very minute, fine detailed nano-printing of certain rectilinear or curvilinear patterns. In a sense, much like how the latent copy-void warning message 32′ is activated on the printed document reproduction 20′ using ink or toner traps, in this case, the nano-patterns 42, 48 are designed to pixelize differently, e.g., one nano-pattern creates more pixels than the other nano-pattern. Such disparity in pixelization causes one of the nano-patterns 42, 48 to exhibit a visual density that increases more than that of the other when the document original 20 is digitally imaged.

As illustrated in FIG. 7, the components of the latent validation message 34 can be designed in a variety of manners by printing the validation nano-patterns 48 with the nano-structures 50 with different angles, sizes and/or densities than that of the nano-structures 46 of the copy-void nano-pattern 42. For example, nano-structures 50(1) located at the bottom of the portion of the copy-void nano-pattern 42 forming the “P” can be printed as thick “0's” that will tend to pixelize more than the nano-structures 46 of the copy-void nano-pattern 42 to form the word “OK”, which appears on the digital document reproduction 20″ as darker areas of clustered pixels (formed by the validation nano-pattern 48(1)) contrasted with lighter pixel areas (formed by the copy-void nano-pattern 42). Likewise, nano-structures 50(1) located at the bottom of the portion of the copy-void nano-pattern 42 forming the “O” can be printed as thick “0's” that will tend to pixelize more than the nano-structures 46 of the copy-void nano-pattern 42 to form the stick-figure symbol, which appears on the digital document reproduction 20″ as darker areas of clustered pixels (formed by the validation nano-pattern 48(1)) contrasted with lighter pixeled areas (formed by the copy-void nano-pattern 42). In these cases, the validation message 34 is entirely formed by the nano-structures 50 of the nano-pattern 48.

As another example, nano-structures 50(2) located at the top of the portion of the copy-void nano-pattern 42 forming the “P” can be printed with a relatively high density that will tend to effect high-density pixelization relative to the pixelization caused by the nano-structures 46 of the copy-void nano-pattern 42 to form the word “OK”, which appears on the digital document reproduction 20″ as relatively small high density pixeled areas (formed by the validation nano-pattern 48(2)) contrasted with relatively large low density dots (formed by the copy-void nano-pattern 42). Likewise, nano-structures 50(2) located within the middles of the portion of the copy-void nano-pattern 42 forming the letters “C”, “O”, “P”, and “Y” can be printed with a relatively high density that will tend to effect high-density pixelization relative to the pixelization caused by the nano-structures 46 of the copy-void nano-pattern 42 to form the letters “V”, “A”, “L”, “I”, and “D”, which appear on the digital document reproduction 20″ as relatively small high density pixeled areas (formed by the validation nano-pattern 48(2)) contrasted with relatively large low density pixeled areas (formed by the copy-void nano-pattern 42) (FIG. 9). In these cases, the outline of the validation message 34 is formed by the nano-structures 50 of the nano-pattern 48. The center of the validation message 34 is actually formed by the background pattern 44, which is so fine that it does not pixelize at all and completely drops out on the digital document message 20″.

Although the latent copy-void warning message 32 and latent validation message 34 have been described as being formed by two separate nano-patterns (i.e., the copy-void nano-pattern 42 and the validation nano-pattern 48), these latent messages can be formed by a single nano-pattern. For example, a single nano-pattern can form the positive of the copy-void warning message 32 and, if printed in a sufficient density, the negative of the validation message 34, with the background 30 or substrate 22 serving as the positive of the validation message. In this case, the single nano-pattern can trap printing matter on the printed reproduction copy 20′ when the document original 20 is electronically copied to activate the latent copy-void warning message 32, and can produce pixels on the digital document reproduction 20″ when the document original 20 is digitally imaged to activate the latent validation message 34.

Referring now to FIGS. 7 and 10, the latent validation message 36 comprises an environmentally dynamic pattern 52 that is embedded within the nano-pattern 42 of the latent copy-void warning message 32 and the background pattern 44 of the background 38. In particular, certain regions within the copy-void nano-pattern 42 and background pattern 44 are replaced with the dynamic pattern 52. Alternatively, the dynamic pattern 52 may be printed over the copy-void nano-pattern 42 and/or background pattern 44. The dynamic pattern 52, along with the copy-void nano-pattern 42 and background pattern 44, are designed, such that the contrast between the dynamic pattern 52 relative to the copy-void nano-pattern 42 and background pattern 44 on the document original 20 during normal viewing conditions substantially increases on the document original 20 during certain environmental conditions in order to activate the validation message 32. Preferably, the dynamic pattern 52 exhibits a visual density that is similar to those of the copy-void nano-pattern 42 and background pattern 44 on the document original 20 during normal viewing conditions (FIG. 7), so that a casual observer cannot readily recognize the validation message 36, but substantially different from those of the copy-void nano-pattern 42 and background pattern 44 on the document original 20 during certain environmental conditions (FIG. 10), so that a casual observer can readily recognize the validation message 36.

In the illustrated embodiment, the dynamic pattern 52 is printed with an environmentally density changing ink, such as thermochromic ink (i.e., an ink the color and/or density of which changes with temperature), whereas the copy-void nano-pattern 42 and background pattern 44 are printed with a conventional non-thermochromic ink. In this manner, the validation message 36 will be activated when sufficient heat is applied to the document verification region 30, e.g., by vigorously rubbing the document verification region 30 or otherwise exposing the document verification region 30 to a heat source. In the illustrated embodiment, the thermochromic ink in which the dynamic pattern 52 is printed is designed to lighten in the presence of heat, such that the dynamic pattern 52 lightens in comparison to the copy-void nano-pattern 42 and background pattern 44 to activate the validation message 36.

Alternatively, the thermochromic ink may be designed to darken in the presence of heat, such that the validation message 36 darkens in comparison to the copy-void pattern 42 and background pattern 44. Such an effect is illustrated in FIG. 5, which shows the activated validation message 36 as being dark relative to the background. However, using a thermochromic ink that causes the validation message 36 to lighten has the added advantage of minimizing the capacity needed to store the digital document reproduction 20″, since the validation message 36 will tend to drop out when the document original 20 is digitally imaged. In either event, the thermochromic ink is preferably reversible in that it will return to its inactivated color in the absence of heat. In this manner, the validation message 36 will become inactivated and essentially disappear unit heat is again applied to the document verification region 30. Thus, any party in possession of the document original 20 will be able to observe the activation and deactivation of the validation message 36, thereby providing an effective and efficient means for authenticating the document original 20.

Further details regarding the use of thermochromic ink to produce validation messages are disclosed in U.S. Pat. Nos. 5,636,874 and 5,873,604, which are expressly incorporated herein by reference.

Referring now to FIG. 7, the camouflage layer 40 comprises a camouflage pattern 54 that is printed over the copy-void nano-pattern 42, validation nano-patterns 48, and dynamically changing pattern 52 in a manner that facilitates the hiding of the respective latent copy-void warning message 32, validation messages 34, and validation message 36 on the document original 20. Alternatively, at least some portions of the camouflage pattern 54 may be printed directly on the substrate 22, in which case, either of the copy-void nano-pattern 42, validation nano-patterns 48, or dynamically changing pattern 52 may be printed over the camouflage pattern 36. In the illustrated embodiment, the camouflage pattern 52 is printed at a visual density that is darker than that of the copy-void nano-pattern 42, validation nano-patterns 48, and dynamically changing pattern 52 to enhance its camouflaging effect.

However, as illustrated in FIG. 8-10, the camouflage pattern 54 is preferably printed using an environmentally density changing ink, such as a thermochromic ink, such that the camouflage pattern 54 lightens when sufficient heat is applied to the document verification region 30, e.g., by vigorously rubbing the document verification region 30 or otherwise exposing the document verification region 30 to a heat source, such as a copy machine or digital scanner. In this manner, the activated copy-void warning message 32 can be more easily seen on the printed document reproduction 20′, the activated validation messages 34 can be more easily seen on the digital document reproduction 20″, and the activated validation message 36 can be more easily seen on the document original 20.

In the embodiment illustrated in FIG. 7, the camouflage pattern 54 is printed as a normally visible repeating message 56, e.g., “CHECK 21 IMAGE SECURE” (shown as the single message “CHECK 21 in FIG. 1). However, if the document verification region 30 takes the form of a bearer information field, such as the signature field, as illustrated in FIG. 6, the normally visible message 56 may take the form of bearer information, such as, in this case, the word “SIGNATURE.” In this manner, the camouflage layer 40 performs the dual function of camouflaging the latent messages, as well as conveying information clearly directing a party to write within the document verification region 30, and in this case, endorsing the document original 20 by writing the party's signature within the document verification region 30. The use of the camouflage pattern 54 to provide bearer information also allows the document verification region 30 to be conveniently moved within a critical bearer field, making it difficult to fraudulently alter due to the presence of the document verification region 30.

It can be appreciated from the foregoing that the dynamic pattern 52 and camouflage pattern 54 advantageously form messages that spatially overlap with one another, yet are capable of being viewed on the same document original 20. That is, the latent validation message 36 has a visual density that changes in the presence of an environmental condition (and in particular, a thermal condition caused by an increase in temperature) to activate the latent validation message 36 on the document original 20, whereas the camouflage pattern 54 forms a normally visible message 56 (in this case, “CHECK 21 IMAGE SECURE” or “SIGNATURE”) having a visual density that changes in the presence of the environmental condition to deactivate the normally visible message.

In the illustrated embodiment, the visual density of the latent validation message 36 is substantially similar to the visual density of the background pattern 44 in the absence of the thermal condition, in which case, the latent validation message 36 can be considered to be deactivated, and lightens in the presence of the thermal condition, so that it is substantially different from the visual density of the background pattern 44, in which case, the latent validation message 36 can be considered to be activated. In contrast, the visual density of the normally visible message 56 is substantially different from (and in this case, darker than) the visual density of the background pattern 44 in the absence of the thermal condition, in which case the normally visible message 56 can be considered to be activated, and lightens in the presence of the thermal condition, so that it is substantially similar to the visual density of the background pattern 44, in which case, the normally visible message 56 can be considered to be deactivated.

When the normally visible message 56 is activated (i.e., the visual densities of the normally visible message 56 and background pattern 44 are different), not only does it convey information to an observer, it camouflages the latent validation message 36 on the document original 20. When the normally visible message 56 is deactivated, however, it essentially disappears into the background pattern 44 (i.e., the visual densities of the normally visible message 56 and background pattern 44 are essentially the same), thereby facilitating the appearance of the latent validation message 36 on the document original 20. As previously discussed above, the normally visible message 56 also camouflages the latent copy-void warning message 32 and latent validation message 34. That is, when activated, the normally visible message 56 camouflages the latent copy-void warning message 32 and latent validation message 34 on the document original 20. When the normally visible message 56 is deactivated, which will occur during an electronic copying or digital imaging operation due to the increased heat, it essentially disappears into the background pattern 44, thereby respectively facilitating the appearance of the latent copy-void warning message 32 and latent validation message 34 on the printed document reproduction 20′ and digital document reproduction 20″.

As previously described above, the document verification region 30 may have additional security features that further facilitate the authentication of the document original 20 and the digital document reproduction 20″. For example, the document verification region 30 comprises a border 56 containing a series of symbols 58, and in this case, pictures of George Washington's head and the American Flag, that will become distorted on the printed document reproduction 20′, as illustrated in FIG. 8. Thus, a review of the border 56, facilitated by a magnification device, such as a simple magnification loupe, will enable a possessor of the document original 20 to verify its authenticity. In this case, the document possessor may need to have somewhat of a trained eye to distinguish between undistorted symbols that should be viewed on the document original 20 and distorted symbols that would otherwise be found on the printed document reproduction 20′.

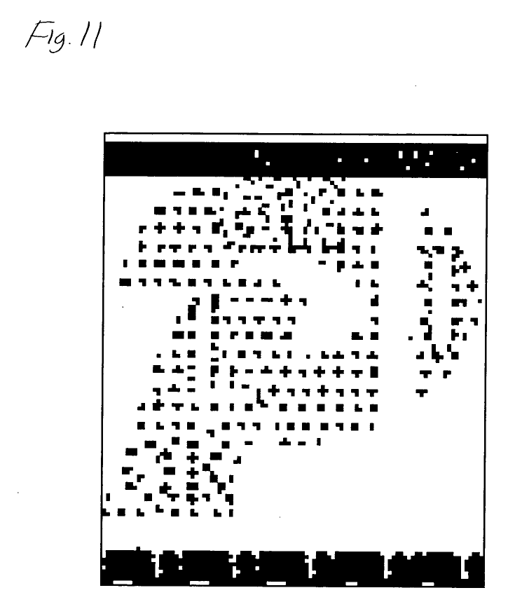

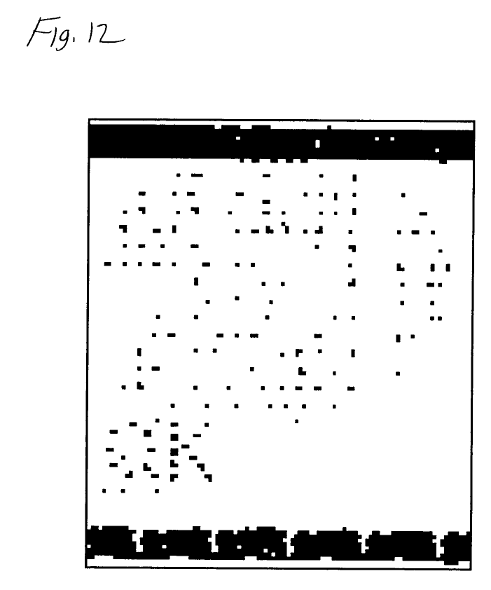

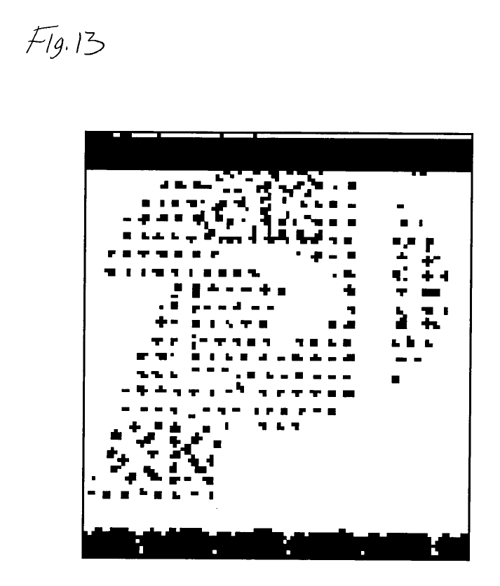

Also, in addition to generating latent messages on the printed document reproduction 20′ and digital document reproduction 20″, the copy-void nano-pattern 42 and validation nano-patterns 48 of digital document reproductions can be forensically examined to determine whether they were generated from the document original 20 or a printed document reproduction 20′. In particular, the nano-patterns 42, 48 will pixelize on a digital document reproduction generated from the document original 20 differently than how they will pixelize on a digital document reproduction generated from the printed document reproduction 20′, thereby creating different pixel patterns. For example, FIGS. 11-13 illustrate magnified views of the “P” of the copy-void warning message 32 that have been pixelized as a result of digitally imaging the document original 20 (FIG. 11), digitally imaging a color copy of the document original 20 (FIG. 12), and digitally imaging a high resolution imaged copy of the document original 20 (FIG. 13). Notably, the digital images illustrated in FIGS. 11-13 were made at a low-resolution, and in particular, at 200 dpi, which as previously described, matches the resolution that banks will typically use when truncating checks.

As can be seen, the “P” of the copy-void warning message 32 pixelizes differently on respective digital images of FIGS. 11-13, with the pixelization between the digital image of the color copy (FIG. 12) and the digital image of the document original 20 (FIG. 11) being quite different. On the other hand, pixelization between the digital image of the high-resolution imaged copy (FIG. 13) and the digital image of the document original 20 (FIG. 11) is somewhat similar. However, the validation nano-patterns 48 provides a variance to the otherwise uniform copy-void nano-pattern 42, thereby enhancing the differences between the pixels of the digital document representation 20″ and a digital reproduction of the printed document representation 20′—even if the printed document representation 20′ was made using a high-resolution image.

Therefore, it can be appreciated that a low-resolution digital image of a document assumed to be the document original 20 can be compared to a low-resolution digital image of a known sample of the document original 20 (e.g., a sample supplied from the printer) to determine whether the digital image of the document to be authenticated was indeed generated from the document original 20. In particular, the pixel pattern representing the copy-void warning message 32 and validation message 34 in the digital document reproduction 20″, or any portion thereof, is compared to the pixel pattern representing the samples of the copy-void warning message 32 and validation message 34, or any portion thereof, and a correlation of pixel pattern differences can then be compared to a threshold value. Preferably, the low-resolution digital image of the document sample is made from a scanner with a resolution that is identical to that used to generate the low-resolution image of the document assumed to be the document original 20, so that a correlation of pixel pattern differences will truly reflect differences in the nano-patterns between the original document original 20 and a printed document reproduction 20′. A comprehensive comparison of the digital images can be made by a computer with specialized software capable of comparing digital images pixel-by-pixel, and making a threshold determination that the pixel pattern differences either indicate that the digital document reproduction was generated from the document original 20 or from a printed document reproduction 20′. It can be appreciated that much like automated identification of the validation message 34 described above, automated comparison of the pixel pattern that create the copy-void warning message 32 and validation message 34 in the digital document reproduction 20″ provides a means for instantaneously detecting counterfeit documents (or in the case of the document original 120 illustrated in FIG. 6, counterfeit or fraudulently altered documents) at the point where the fraudulent documents are digitally imaged.

Although particular embodiments of the present invention have been shown and described, it should be understood that the above discussion is not intended to limit the present invention to these embodiments. Those of ordinary skill in the art will appreciate that various changes and modifications may be made without departing from the spirit and scope of the present invention. Thus, the present invention is intended to cover alternatives, modifications, and equivalents that may fall within the spirit and scope of the present invention as defined by the claims.

1. An original document, comprising:
a printable substrate;
a first security feature carried by the substrate, the first security feature forming a latent copy-void warning message that visually appears on an electronically printed reproduction of the document original; and
a second security feature carried by the substrate and at least partially embedded within the first security feature, the second security feature forming a latent validation message that visually appears on a digital reproduction of the document original.

2. The document of claim 1, wherein the first security feature comprises nano-structures configured for trapping printing matter on the printed document reproduction, such that the nano-structures form the latent copy-void warning message, and the second security feature comprises nano-structures configured for forming a pixel pattern on the digital document reproduction, such that the nano-structures form the latent validation message.

3. The document of claim 1, wherein the latent validation message is an alphanumeric message.

4. The document of claim 1, wherein the latent validation message is a symbolic message.

5. The document of claim 1, further comprising a third security feature carried by the substrate and forming another latent validation message that visually appears on the document original.

6. The document of claim 5, wherein the third security feature is at least partially embedded within the first security feature.

7. The document of claim 5, wherein the third security feature comprises thermochromic ink configured for changing in visual density, such that the thermochromic ink forms the other latent validation message.

8. The document of claim 5, further comprising a camouflage layer spatially overlapping the first and third security features, wherein the camouflage layer comprises a pattern that facilitates hiding of the latent copy-void warning message and the other latent validation message on the document original during normal viewing conditions.

9. The document of claim 1, further comprising bearer information printed on the substrate.

10. The document of claim 9, wherein the bearer information is bank check information.

11. A method of authenticating the document of claim 1, comprising:
creating a digital reproduction of the document original; and
examining the digital document reproduction for the appearance of the validation message.

12. The method of claim 11, wherein the digital document reproduction is examined manually.

13. The method of claim 11, wherein the digital document reproduction is machine examined automatically.

14. An original document, comprising:
a printable substrate;
a first plurality of nano-structures arranged on the substrate in a manner that forms a latent copy-void warning message that visually appears on an electronically printed reproduction of the document original; and
a second plurality of nano-structures arranged on the substrate at least partially within the first plurality of nano-structures in a manner that forms a latent validation message that visually appears on a digital reproduction of the document original.

15. The document of claim 14, wherein the first plurality of nano-structures is configured for trapping printing matter to activate the latent copy-void warning message on the printed document reproduction, and the second plurality of nano-structures is configured for forming a pixel pattern to activate the latent validation message on the digital document reproduction.

16. The document of claim 14, wherein the second plurality of nano-structures forms a center of the latent validation message.

17. The document of claim 14, wherein the second plurality of nano-structures forms in outline of the latent validation message.

18. The document of claim 14, wherein the latent validation message is an alphanumeric message.

19. The document of claim 14, wherein the latent validation message is a symbolic message.

20. The document of claim 14, wherein the first and second pluralities of nano-structures are less than two-point print size.

21. The document of claim 14, wherein the first and second pluralities of nano-structures are less than one-point print size.

22. The document of claim 14, wherein at least some of the first plurality of nano-structures differ from at least some of the second plurality of nano-structures.

23. The document of claim 14, wherein the first and second pluralities of nano-structures are printed on the substrate at different angles, sizes and/or densities.

24. The document of claim 14, wherein the second plurality of nano-structures is completely within the first plurality of nano-structures.

25. The document of claim 14, further comprising thermochromic ink arranged on the substrate at least partially within the first plurality of nano-structures in a manner that forms another latent validation message that visually appears on the document original when thermally heated.

26. The document of claim 25, further comprising a camouflage layer disposed over the first plurality of nano-structures and the thermochromic ink, wherein the camouflage layer comprises a pattern that facilitates hiding of the latent copy-void warning message and the other latent validation message on the document original during normal viewing conditions.

27. The document of claim 14, further comprising bearer information printed on the substrate.

28. The document of claim 14, wherein the bearer information is bank check information.

29. A method of authenticating the document of claim 14, comprising:
creating a digital reproduction of the document original; and
examining the digital document reproduction for the appearance of the validation message.

30. The method of claim 29, wherein digital document reproduction is examined manually.

31. The method of claim 29, wherein digital document reproduction is machine examined automatically.

32. An original document, comprising:
a printable substrate;
a plurality of nano-structures carried by the substrate, the nano-structures forming a first latent message that visually appears on a reproduction of the document original, and forming a second latent message that visually appears at least partially within the first latent message on the document reproduction.

33. The document of claim 32, wherein the document reproduction is an electronically printed reproduction of the document original.

34. The document of claim 32, wherein the document reproduction is a digital reproduction of the document original.

35. The document of claim 32, wherein the nano-structures are less than two-point print.

36. The document of claim 32, wherein the nano-structures are less than one-point print.

37. The document of claim 32, wherein at least some of the nano-structures differ from each other.

38. The document of claim 32, wherein at least some of the nano-structures are printed at different angles, sizes and/or densities.

39. The document of claim 32, further comprising thermochromic ink arranged on the substrate at least partially within the nano-structures, and configured for changing in visual density, when thermally heated, such that the thermochromic ink forms a third latent message that visually appears on the document original.

40. The document of claim 39, further comprising a camouflage layer disposed over the nano-structures and the thermochromic ink, wherein the camouflage layer comprises a pattern that facilitates hiding of the latent copy-void warning message and the other latent validation message on the document original during normal viewing conditions.

41. The document of claim 32, further comprising bearer information printed on the substrate.

42. The document of claim 41, wherein the bearer information is bank check information.

43. An original document, comprising:
a printable substrate;
a first nano-pattern arranged on the substrate, and configured for trapping printing matter on an electronic reproduction of the document original, such that the first nano-pattern forms a first latent message that visually appears on the printed document reproduction; and
a second nano-pattern arranged on the substrate at least partially within the first nano-pattern, and configured for forming a pixel pattern on a digital reproduction of the document original, such that the second nano-pattern forms a second different latent message that visually appears on the digital document reproduction.

44. The document of claim 43, wherein the pixel pattern forms a center of the second latent message.

45. The document of claim 43, wherein the pixel pattern forms in outline of the second latent message.

46. The document of claim 43, wherein the second latent message is an alphanumeric message.

47. The document of claim 43, wherein the second latent message is a symbolic message.

48. The document of claim 43, wherein the first and second nano-patterns are less than two-point print.

49. The document of claim 43, wherein the first and second nano-patterns are less than one-point print.

50. The document of claim 43, wherein the first nano-pattern is configured for forming a pixel pattern on the digital document having a visual density substantially different from the pixel pattern created by the second nano-pattern.

51. The document of claim 43, wherein the second nano-patent is completely surrounded by the first nano-pattern.

52. The document of claim 43, further comprising thermochromic ink arranged on the substrate and configured for changing in visual density, when thermally heated, such that the thermochromic ink forms a third latent validation message that appears on document original.

53. The document of claim 52, wherein the thermochromic ink is arranged on the substrate at least partially within the first nano-pattern.

54. The document of claim 53, further comprising a camouflage layer disposed over the first nano-pattern and the thermochromic ink, wherein the camouflage layer comprises a pattern that facilitates hiding of the first and third latent messages on the document original during normal viewing conditions.

55. The document of claim 43, further comprising bearer information printed on the substrate.

56. The document of claim 55, wherein the bearer information is bank check information.

57-119. (canceled)
